(19) United States
(12) Patent Application Publication
(10) Pub. No.: US 2013/0306271 A1
(43) Pub. Date: Nov. 21, 2013

(54) Blowing Device and Method for Using the Blowing Device

(71) Applicants: Shaoxin Yu, Shenzhen (CN); Song Xiao, Shenzhen (CN); Yun Wang, Shenzhen (CN)

(72) Inventors: Shaoxin Yu, Shenzhen (CN); Song Xiao, Shenzhen (CN); Yun Wang, Shenzhen (CN)

(73) Assignee: SHENZHEN CHINA STAR OPTOELECTRONICS TECHNOLOGY CO., LTD., Shenzhen (CN)

(21) Appl. No.: 13/518,846

(22) PCT Filed: May 24, 2012
(86) PCT No.: PCT/CN12/75979

§ 371 Date: Jun. 22, 2012

(30) Foreign Application Priority Data
May 18, 2012 (CN) 201210156398.9

(51) Int. Cl. F28D 15/00

(52) U.S. Cl. 165/104.13; 165/104.34

(57) ABSTRACT

The present invention provides a blowing device and a method of using the blowing device. The a blowing device comprises a heat generating device, a first chamber having an inlet and an outlet embodied as a slit. A second and third chamber is arranged in juxtapose with the sides of the first chamber. And wherein the second and third chambers are heated by the heat generating device. With the arranged provided above, the blowing device can be prevented from condensed droplets on its surfaces so as to prevent the droplets reentered into the air flow blowing across a surface of an object.

### FIELD OF THE INVENTION

The present invention relates to a technical field of drying, and more particularly to a blowing device and method for using the blowing device.

### BACKGROUND OF THE INVENTION

Air knife (AF) is a pressurized air plenum used to blow off liquid or debris from products as they travel on conveyors or the like. In general, the air knife contains a series of holes or continuous slots through which pressurized air exits in a laminar flow pattern. The exit air velocity then creates an impact air velocity onto the surface of whatever object the air is directed. Once the pressured air plenum is blown over the surface of the object, liquid, droplet, or dust will be readily blown away so as to achieve a clean and drying effect. As shown in FIG. 1, the typical air knife includes an inlet 11, a chamber 12 and an outlet 13.

The working principle of the air knife is typically described as below. Pressurized, purified air, or generally referred to as Clean Dry Air (CDA) is directed into the chamber 12 of the air knife through inlet 11, and then the pressurized CDA is blown out through the outlet or nozzle 13. Since the nozzle 13 is merely a slit, which creates a gradient for the pressurized air such that the exit air velocity then creates an impact air velocity onto the surface of whatever object the air is directed. As a result, the air knife can be used to remove liquid from a surface it directs, or it can blow away small particles and dust. One of the applications of the air knife in the industry is in the manufacturing of Thin Film Transistor Liquid Crystal Display (TFT LCD). The air knife is introduced to remove the liquid from the surface of the glass substrate.

In the existing field, the working environment of the air knife where the TFT LCD is dried is a humid and hot. The air knife is typically made from metal and it has a comparably low temperature with respect to the ambient environment. As a result, the outer surface of the air knife will readily be accumulated with condensed droplets, and it may be carried by the compressed air flow and lands onto the surface of the glass substrate which is intended to be dried. Accordingly, the droplets really create a negative influence to the drying and dewatering result.

### SUMMARY OF THE INVENTION

It is a primary object of the present invention to provide a blowing device and a method for using the blowing device in which the droplets condensed on an outer surface of an air knife can be readily prevented from re-entering the pressurized air flow so as to ensure the drying result.

In order to resolve the prior art issue, the present invention provides a solution by introducing a blowing device comprising a heat generating device, a first chamber having an inlet and an outlet embodied as a slit. A second and third chamber is arranged in juxtapose with the first chamber. Wherein the first and second chambers are separated from the third chamber, while the second chamber is in communication with the third chamber; and wherein the second and third chambers are heated by the heat generating device.

Wherein the heat generating device is a liquid circulating heating system containing conduit and medium filled within the conduit, and a heating unit used to heat up the medium, wherein the second and third'chambers are part of the conduit.

Wherein the outlet of the first chamber has a first side surface and a second side surface, and the first, second, and third chambers are integrally formed, the first and second chambers share the first side surface, and the first and third chambers share the second side surface.

Wherein the medium is do-ionized water.

Wherein the heat generating device includes a thermostat used to monitor and controlling the heating unit such that a temperature of the medium is kept between 80 to 100 degrees Celsius.

In order to resolve the prior art issue, the present invention provides a solution by introducing a blowing device comprising a heat generating device, a first chamber having an inlet and an outlet embodied as a slit. A second and third chambers arranged in juxtapose with the sides of the first chamber. And wherein the second and third chambers are heated by the heat generating device.

Wherein the first chamber and second chamber are separated from third chamber.

Wherein the heat generating device is a liquid circulating heating system containing conduit and medium filled within the conduit, and a heating unit used to heat up the medium, wherein the second and third chambers are part of the conduit.

Wherein the outlet of the first chamber has a first side surface and a second side surface, and the first, second, and third chambers are integrally formed, the first and second chambers share the first side surface,' and the first and third chambers share the second side surface.

Wherein the second and third chambers are in communication with each other.

Wherein the medium is de-ionized water.

Wherein the heat generating device includes a thermostat used to monitor and controlling the heating unit such that a temperature of the medium is kept between 80 to 100 degrees Celsius.

In order to resolve the prior art issue, the present invention provides a solution by introducing a method of using a blowing device, comprising the steps of a) providing a first chamber with pressurized air directed therein from an inlet, and directing the pressurized air out of the first chamber from a slit thereof. The method further includes a step of heating side surfaces of the first chamber in which the slit is located as the pressurized air blows out of the slit.

Wherein the step of heating the side surfaces of the first chamber further includes the step of providing a second and third chambers on the side surfaces of the first chamber, and directing heated medium within the first and second chambers so as to heat up the side surfaces of the first chamber.

Wherein the medium is kept between 80 to 100 degrees Celsius.

The present invention can be concluded with the following advantages. As compared to the existing prior art, the first chamber in which pressurized air plenum is stored is further provided with the second and third chambers juxtaposed on side surfaces of the first chamber. The second and third chambers are heated accordingly so as to prevent any condensed droplet formation on the surface area of the first chamber thereby effectively prevent the droplet from reentering the pressurized air plenum blowing across the surface of the object, ensuring the best result.

### BRIEF DESCRIPTION OF DRAWINGS

FIG. 1 is a cross sectional view of a prior art air knife;

FIG. 2 is a perspective view of an air knife made in accordance with the present invention; and

FIG. 3 is a block diagram showing the procedures of using the air knife made in accordance with the present invention.

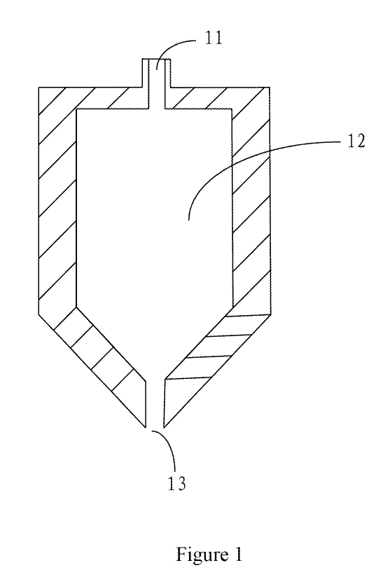

### DETAILED DESCRIPTION OF PREFERRED EMBODIMENT

A detailed description will be given along with the accompanied drawings.

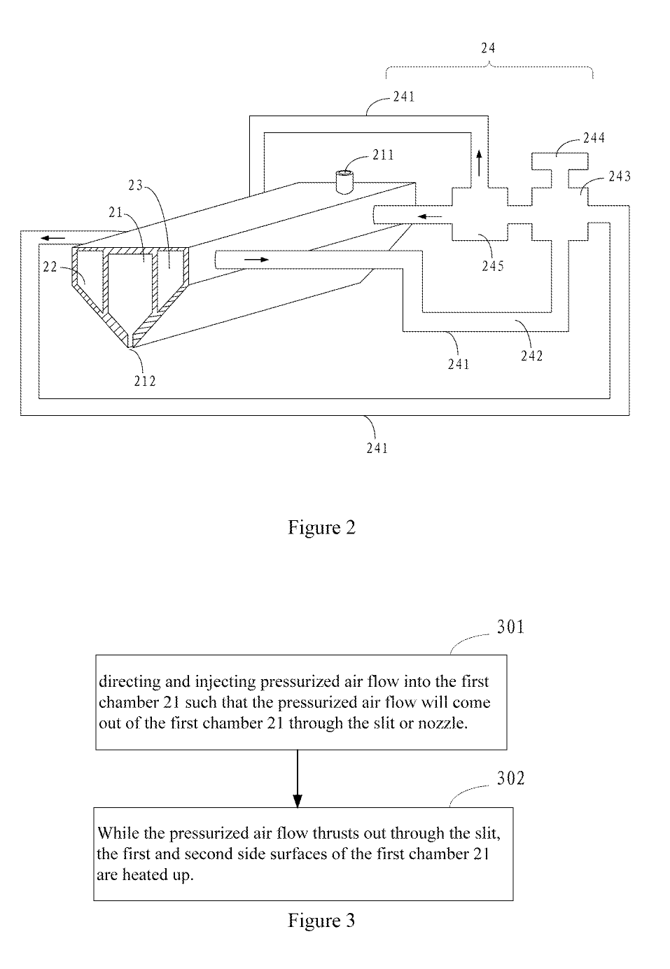

Referring to FIG. 2, a perspective view of an air knife made in accordance with the present invention. As shown, the blowing device generally includes a first chamber 21, a second chamber 22, a third chamber 23, and a heat generating device N.

The heat generating device 24 is a liquid circulating heating system configured with a conduit 241 and medium 242 filled within the conduit 241, and a heating unit 243 used to heat up the medium 242, a thermostat 244, and a pump 245. Wherein the second and third chambers 22 and 23 are part of the conduit 241.

Wherein the first chamber 21 is provided with an inlet 211 and an outlet 212. The outlet 212 of the first chamber 21 is embodied in a form of a slit, or a nozzle.

As shown, the second and third chambers 22 and 23 are arranged in juxtaposed on both side surfaces of the outlet 212, i.e. first and second side surfaces of the outlet 212. The second and third chambers 22 and 23 are individually separated from the first chamber 21. Substantially, the sides surfaces mentioned above are located on side of the outlet 212 of the first chamber 21. (Not labeled in Figure) The first, second and third chambers 21, 22, and 23 are integrally formed together. The first and second chambers 21 and 22 share the first side surface, while the first and third chambers share the second surface.

The heat generating device is used to heat up the second and third chambers 22 and 23. The second and third chambers 22 and 23 are in communication with each other. Alternatively, the second and third chambers 22 and 23 can be heated by other suitable devices. Alternatively, the second and third chambers 22 and 23 can be embodied without any inter-communication therebetween.

The medium 242 used in the conduit 241 of the heat generating device 24 is a de-ionized water (DIW), or alternatively, it can be any suitable heating medium. During the heating process, the thermostat 244 is used to monitor and control the heating unit 244 and the temperature of the medium 242. Preferably, the temperature of the medium 242 is kept between 80 to 100 degrees Celsius. Preferably, the temperature can be set to 90 degrees Celsius.

Alternatively, the heat generating device 24 can be embodied without the conduit 241 and the medium 242 while to provide a head-to-head contact to the second and third chambers 22 and 23.

An air knife will be used to illustrate the blowing device made in accordance with the present invention.

In order to prevent the air knife from accumulating with condensed droplet on its surfaces, the air knife made in accordance with the present invention is provided with a heat generating device so as to prevent the droplet from condensing on the outer surface of the air knife. Substantially, it is embodied as below.

Referring still to FIG. 2, on both side surfaces, i.e. first and second side surfaces, of the first chamber 21 of the air knife are each provided or attached with the second and third chambers 22 and 23 filled with heated medium, such as the de-ionized water (DEW) through the conduit 242. The heat exchange between the second and third chambers 22 and 23 with respect to the first chamber 21 will heat up the outer surface of the first chamber 21.

The heat generating device 24 further includes the conduit 241, the medium 242, the heating unit 243, the thermostat 244, and a pump 245. Alternatively, the second and third chambers 22 and 23 are also part of the conduit 241. Accordingly, the conduit 241, the medium 242, the heating unit 243, the thermostat 244, and a pump 245 jointly configure a heat circulating system.

The medium 242 is heated by the heating unit 243, and its temperature is monitored and controlled by the thermostat 244. As result, the temperature of the medium 242 is preferably controlled between 80 to 100 degrees Celsius. Once the medium 242 is heated to the preset temperature, with the function of the pump 245, the medium 242 is pushed to the second and third chambers 22 and 23. Since the second and third chambers 22 and 23 are arranged in juxtaposed with the first chamber 21 in its first and second side surfaces, a heat exchange will be incurred between the first and second chambers 21 and 22; and the first and third chambers 21 and 23. Accordingly, the energy from the medium 242 will be transferred to the first chamber 21. Once the first, second and third chambers 21, 22, and 23 are heated up and kept in an elevated temperature, the condensed droplet will not be formed on the other surface of the air knife. By this arrangement, since no droplet will be formed on the outer surface of the air knife, no risk of reentering of the droplet into the pressurized air flow will be encountered.

For example, when the temperature of the medium 242 pumped into the second and third chambers 22 and 23 reaches to 90 degrees Celsius, then the temperature on the outer surface of the air knife will also reach to 90 degrees Celsius. In such a high temperature, the condensed droplet will be difficult to form.

The heat transfer or heat flow between the medium 242, the second and third chambers 22 and 23 can be readily expressed by the following formula. For example, if the length of the second and third chambers 22 and 23 are 2 meters, with a width of 10 centimeter, and a thickness of its wall of 1 centimeter, in the very beginning, the temperature of the outer surface will be equivalent to the ambient temperature, i.e. around 20 degrees Celsius. Then, according to the following heat conductive formula.

$$dQ = - λ \cdot ds \cdot \frac{\partial t}{\partial n}$$

Wherein the Q represents the heat transferred, s represents the conductive surface, ∂t represents gradients of temperatures between ends of the conductive material, n represents length of the conductive material, λ represents heat conductive coefficient. In general, λ=53.6 W/(m·° C. ). In the very beginning, the heat transfer on the outer surface of the air knife equals to dQ=53.6×2×0.1×(90−20)/0.01=75.04 kW. Once the air flow is heated up to about 90 degrees Celsius, ∂t→0, and there is substantial no heat transfer therebetween. In this situation, the medium 242 will keep on sustain the temperature of the air knife to the 90 degrees Celsius.

While the heat is transferred from the medium 242 to the second and third chambers 22 and 23, and eventually reaches to the first chamber 21, the heat built up on the first chamber 21 will also conduct a heat transfer to the clean dry air (CDA) within the first chamber 21. Once the temperature of the CDA is elevated, its function of drying increases as well. Accordingly, once this pressurized, dried and heated air blown to the surface to be cleaned and dried, for example, a surface of a glass substrate, a better result can be reached. In some manufacturing process, once the object is undergone the process of cleaning and drying with the knife, the object will be further undergone a process of baking. As the pressurized air blown to the object may also beat up the object, the air knife is therefore serves as a preheating device which will benefit the layer tack time of the object.

In addition, once the CDA is heated up, the usage of the CDA can be reduced as well. According to pneumatic formula, PV=nRT. For example, the temperature of the CDA before the heating process is around 20 degrees Celsius, then P1V1=nRT1. If the temperature after the heating process reaches to 90 degrees Celsius, then P2V2=nRT2. V1=(T1/T2)·V2=(273+20)/(273+90)·V2=80.1%, as a result, a saving of 19.9% of CDA is reached.

The improvement of the present invention to the air knife can readily prevent any condensed droplet formation on the surface area of the first chamber thereby effectively prevent the droplet from reentering the pressurized air plenum blowing across the surface of the object, ensuring the best result. In addition, as the CDA is heated up as well, not only the dewatering efficiency can be increased, but also reduce the usage of the CDA.

Referring now to both FIGS. 2 and 3, a block diagram showing the procedures of using the air knife made in accordance with the present invention. The application of the air knife will be detailed as below.

Step 301: directing and injecting pressurized air flow into the first chamber 21 such that the pressurized air flow will come out of the first chamber 21 through the slit or nozzle.

Step 302: While the pressurized air flow thrusts out through the slit, the first and second side surfaces of the first chamber 21 are heated up.

The second and third chambers 22 and 23 are arranged on the first and second surfaces of the first chamber 21, and are circulated with heated medium 242 such that the first and second surfaces of the first chamber 21 are heated. The slit is located between the first and second surfaces. The temperature of the medium 242 within the second and third chambers 22 and 23 are set between 80 to 100 degrees Celsius.

According to the present invention, the first chamber 21 in which pressurized air plenum is stored is provided with the second and third chambers 22, 23 juxtaposed on side surfaces of the first chamber 21. The second and third chambers 22, 23 are heated accordingly so as to prevent any condensed droplet formation on the surface area of the first chamber thereby effectively prevent the droplet from reentering the pressurized air plenum blowing across the surface of the object, ensuring the best result.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

1. A blowing device, comprising:
a heat generating device, a first chamber having an inlet and an outlet embodied as a slit;
a second and third chambers arranged juxtaposed with the first chamber, wherein the first and second chambers are separated from the third chamber, while the second chamber is in communication with the third chamber;
wherein the second and third chambers are heated by the heat generating device.

2. The blowing device as recited in claim 1, wherein the heat generating device is a liquid circulating heating system containing conduit and medium filled within the conduit, and a heating unit used to heat up the medium, wherein the second and third chambers are part of the conduit

3. The blowing device as recited in claim 1, wherein the outlet of the first chamber has a first side surface and a second side surface, and the first, second, and third chambers are integrally formed, the first and second chambers share the first side surface, and the first and third chambers share the second side surface.

4. The blowing device as recited in claim 2, wherein the medium is de-ionized water.

5. The blowing device as recited in claim 2, wherein the heat generating device includes a thermostat used to monitor and controlling the heating unit such that a temperature of the medium is kept between 80 to 100 degrees Celsius.

7. A blowing device, comprising:
a heat generating device, a first chamber having an inlet and an outlet embodied as a slit;
a second and third chambers arranged juxtaposed with the sides of the first chamber; and
wherein the second and third chambers are heated by the beat generating device.

7. The blowing device as recited in claim 6, wherein the first chamber and second chamber are separated from third chamber.

8. The blowing device as recited in claim 6, wherein the heat generating device is a liquid circulating heating system containing conduit and medium filled within the conduit, and a heating unit used to heat up the medium, wherein the second and third chambers are part of the conduit.

9. The blowing device as recited in claim 7, wherein the outlet of the first chamber has a first side surface and a second side surface, and the first, second, and third chambers are integrally formed, the first and second chambers share the first side surface, and the first and third chambers share the second side surface.

10. The blowing device as recited in claim 8, wherein the second chamber and the third chamber are in communication with each other.

11. The blowing device as recited in claim 8, wherein the medium is de-ionized water.

12. The blowing device as recited in claim 8, wherein the heat generating device includes a thermostat used to monitor and controlling the heating unit such that a temperature of the medium is kept between 80 to 100 degrees Celsius.

13. A method of using a blowing device, comprising the steps of:
a) providing a first chamber with pressurized air directed therein from an inlet, and directing the pressurized air out of the first chamber from a slit thereof; and
b) heating side surfaces of the first chamber in which the slit is located as the pressurized air blows out of the slit.

14. The method as recited in claim 13, wherein the step of heating the side surfaces of the first chamber further includes the step of providing a second and third chambers on the side surfaces of the first chamber, and directing heated medium within the first and second chambers so as to heat up the side surfaces of the first chamber.

15. The method as recited in claim 14, wherein the medium is kept between 80 to 100 degrees Celsius.
